(19) United States
(12) Patent Application Publication
(10) Pub. No.: US 2006/0128826 A1
(43) Pub. Date: Jun. 15, 2006

(54) Ultra-thin thiol-ene coatings

(76) Inventors: Matthew M. Ellison, Mason, OH (US); Devdatt S. Nagvekar, Hamilton, OH (US); Eric G. Spencer, Brookville, IN (US); Paul E. Snowwhite, South Lebanon, OH (US)

Correspondence Address: RESOLUTION PERFORMANCE PRODUCTS LLC;ATTN: LISA JONES, 1600 SMITH STREET, P.O. BOX 4500, HOUSTON, TX, 77210-4500, US

(21) Appl. No.: 11/270,769

(22) Filed: Nov. 9, 2005

Related U.S. Application Data
(60) Provisional application No. 60/629,103, filed on Nov. 18, 2004.

(51) Int. Cl. C08J 3/28

(52) U.S. Cl. 522/127

(57) ABSTRACT

Disclosed herein are ultra-thin thiol-ene coatings exhibiting optical clarity, scratch resistance, chemical resistance, and adhesion to a variety of substrate materials.

### RELATED APPLICATION DATA

This application claims the benefit of U.S. Provisional Application Ser. No. 60/629,103 filed Nov. 18, 2004, the entire contents of which are hereby incorporated by reference.

### BACKGROUND OF INVENTION

Cured (meth)acrylate-based materials exhibit a variety of desirable properties including optical clarity and hardness, to name a few. Typical ultraviolet radiation curable (meth)acrylate materials are known to experience oxygen inhibition when cured. For thick layers of curable material, the oxygen inhibition is limited to the surface of the material. For very thin layers of curable material, however, the oxygen inhibition becomes a bulk problem as opposed to a surface issue. Because of the problem of oxygen inhibition, the use of ultraviolet radiation curable (meth)acrylate materials to prepare very thin layers or coatings results in cured products exhibiting insufficient adhesion to a substrate or insufficient hardness.

Excluding oxygen from the curable materials during curing requires special conditions and/or equipment rendering the overall process less convenient and more costly.

There remains a need for energy curable materials that, when cured as thin layers without excluding the presence of oxygen, provides a cured material having good adhesion to a variety of substrate materials, quick cure, sufficient hardness, minimal shrinkage, sufficient substrate wetting, sufficient optical clarity, and chemical resistance.

### BRIEF DESCRIPTION OF THE INVENTION

In one embodiment, a cured film comprises the reaction product obtained by radiation curing a curable thiol-ene composition, wherein the thiol-ene composition comprises a multifunctional ethylenically unsaturated compound; a multifunctional thiol compound; and optionally a polymerization initiator, an adhesion promoter, a stabilizer, a surfactant, conductive filler, or a combination thereof, wherein the cured film has a thickness of less than about 10 micrometers.

Other embodiments include articles prepared from the cured film, methods of preparing the cured film, and the like.

### DETAILED DESCRIPTION

Disclosed herein are curable thiol-ene compositions comprising one or more multifunctional ethylenically unsaturated compounds and one or more multifunctional thiol compounds that when cured as ultra-thin coatings and films in the presence of oxygen provide an optically clear, durable material with good adhesion to a variety of substrate materials, good hardness giving good abrasion resistance, as well as good solvent, alkali, and acid resistance.

The terms “a” and “an” herein do not denote a limitation of quantity, but rather denote the presence of at least one of the referenced item. All ranges disclosed herein are inclusive and combinable.

As used herein, “ultra-thin films” include layers, films, and coatings having a thickness of less than about ten micrometers.

The curable thiol-ene compositions generally comprise one or more multifunctional ethylenically unsaturated compounds, including monomers and/or oligomers, and one or more multifunctional thiol compounds. Ideally, these compounds should be chosen in order to create a three-dimensional polymer network sufficiently free of bonds that are easily susceptible to hydrolysis in the presence of a base, such as ester groups, so as to withstand immersion in an alkali solution without affecting film integrity. As such, tri-, tetra-, and higher functionality materials are preferred, but difunctional materials can be used as well. As used herein, functionality defines the number of reactive groups, either mercapto or ethylenically unsaturated, in the compound. An added advantage of these higher functional compounds is an increase in cure speed.

Suitable multifunctional ethylenically unsaturated compounds are monomers or oligomers comprising two or more ethylenically unsaturated groups per molecule. The ethylenically unsaturated groups include a carbon-carbon double bond such as those found in the following functional groups: allyl, vinyl, acryloxy, methacryloxy, acrylamido, methacrylamido, acetyleneyl, maleimido, and the like. As used herein, the prefix “(meth)acryl-” is inclusive of both acryl- and methyacryl- groups.

Suitable multifunctional ethylenically unsaturated compounds include, for example, compounds containing a core structure linked to ethylenically unsaturated groups, optionally via a linking group. The linking group can be an ether, ester, amide, urethane, carbamate, or carbonate functional group. In some instances, the linking group is part of the ethylenically unsaturated group, for instance an acryloxy or acrylamido group. The core group can be an alkyl (straight and branched chain alkyl groups), aryl (e.g. phenyl), polyether, siloxane, urethane, or other core structure and oligomers thereof. Exemplary multifunctional ethylenically unsaturated compounds include tri-allyl isocyanurate; tri-vinyl isocyanurate; diallyl maleate; diallylether bisphenol A; ortho diallyl bisphenol A; triallyl trimellitate; tri(meth)acryl triols such as trimethylolpropane tri(meth)acrylate; triallyl triols such as 1-(allyloxy)-2,2-bis((allyloxy)methyl)butane; polyvinyl polyols such as 1-(vinyloxy)-2,2-bis((vinyloxy)methyl)butane; polyallyl polyols; polyvinyl polyetherpolyols; polyallyl polyetherpolyol; etc.

Suitable multifunctional ethylenically unsaturated oligomer compounds include, for example, vinyl terminated siloxane; allyl terminated siloxane; vinylalkylsiloxane homopolymers or copolymers; allylalkylsiloxane homopolymers or copolymers; allyl polysilsesquioxanes; vinyl polysilsesquioxanes; combinations thereof, and the like.

In one embodiment, the multifunctional ethylenically unsaturated oligomer is free of groups susceptible to base hydrolysis, such as ester groups and carbonate groups.

In one embodiment, the multifunctional ethylenically unsaturated compound is not a siloxane or silsesquioxane polymer. In another embodiment, the multifunctional ethylenically unsaturated compound is free of bicyclic groups.

One or more multifunctional ethylenically unsaturated compounds can be present in the curable thiol-ene composition. The choice of multifunctional ethylenically unsaturated materials can be made to provide a cured ultra-thin layer having a variety of properties such as solvent resistance and hardness. Typically, the amount of multifunctional ethylenically unsaturated compound in the curable thiol-ene composition can be present in a ratio of unsaturated functionality:thiol functionality of about 0.40:1.00 to about 2.50:1.00, specifically about 0.50:1.00 to about 2.00:1.00; more specifically about −0.75:1.00 to about 1.25:1.00, yet more specifically about 0.85:1.00 to about 1.20:1.00, still yet more specifically about 0.95:1.00 to about 1.05:1.00, and further more specifically in a stoichiometric amount.

The multifunctional thiol compounds can comprise two or more thiol (“mercapto”; —SH) groups per molecule. The multifunctional thiol compound can be monomers or oligomers. Exemplary multifunctional thiol monomers include alkyl thiol compounds such as 1,2-dimercaptoethane, 1,6-dimercaptohexane, neopentanetetrathiol, and the like, pentaerythritol tetra(3-mercapto propionate), 2,2-bis(mercaptomethyl)-1,3-propanedithiol, and the like, aryl thiol compounds such as 4-ethylbenzene-1,3-dithiol, 1,3-diphenylpropane-2,2-dithiol, 4,5-dimethylbenzene-1,3-dithiol, 1,3,5-benzenetrithiol, glycol dimercaptoacetate, glycol dimercaptopropionate, pentaerythritol tetrathioglycolate, trimethylolpropane trithioglycolate, and the like.

Suitable oligomeric multifunctional thiols include, for example, polysiloxanes, polymers having a siloxane-based backbone and further comprising two or more thioalkyl groups pendent from the backbone. These multifunctional thiols can have repeat units according to the general formula RₙSiO_{(4-n)/2} wherein each R is independently i) a C₁-C₁₀ alkyl, optionally substituted with a thiol group or a halogen group (e.g. Cl, Br, I, or F), or ii) an aryl group such as phenyl; n is 1-2, with an average value of about 1.2-1.8; where at least two R per molecule are C₁-C₁₀ alkyl substituted with a thiol group, specifically at least about 25 percent, more specifically at least about 35 percent, and yet more specifically at least about 45 percent of the R groups per molecule are C₁-C₁₀ alkyl substituted with a thiol group. The general average unit formula is the summation of individual siloxane units which are SiO₂ units, RSiO_{3/2} units, R₂SiO units, R₃SiO_{1/2} units and each R in each unit is as defined herein. Each siloxane unit does not need to be present in each oligomeric multifunctional thiol polymer. The C₁-C₁₀ alkyl group includes both straight and branched chain alkyl groups, and specifically saturated alkyl groups. Exemplary alkyl groups include methyl, ethyl, propyl, isopropyl, n-butyl, iso-butyl, tert-butyl, n-hexyl, cyclohexyl, octyl, and the like. The polysiloxanes can optionally contain residual silicon-bonded groups that result from their preparation, such as hydroxyl groups (Si—OH) and alkoxy groups (Si—OR).

In a particular embodiment, the multifunctional thiol has repeat units according to the general formula RₙSiO_{(4-n)/2} wherein each R is independently i) a C₁-C₁₀ alkyl, optionally substituted with a thiol group or a halogen group (e.g. Cl, Br, I, or F), or ii) an aryl group such as phenyl; n is 2, where at least about 25 percent, specifically at least about 35 percent, and more specifically at least about 45 percent of the R groups per molecule are C₁-C₁₀ alkyl substituted with a thiol group and the remaining groups are unsubstituted C₁-C₁₀ alkyl. These oligomers can be terminated by any number of functional groups including hydroxyl, alkoxy, alkyl, mercapto, and the like.

Also suitable are polyethylene glycol dimercaptoacetate oligomers.

Exemplary oligmeric multifunctional thiols include (mercaptoalkyl)alkylsiloxane homopolymers or copolymers, such as (mercaptopropyl)methylsiloxane homopolymers or copolymers, mercapto terminated oligomers, mercapto containing polysilsesquioxanes, and the like. Examples of polyorganosiloxanes having alkylthiol groups can be found in U.S. Pat. Nos. 3,445,419, 4,284,539, and 4,289,867, incorporated herein by reference. Examples of other oligomeric multifunctional thiols can be found in U.S. Pat. No. 3,661,744. Combinations of one or more multifunctional thiol compounds can be used in the curable compositions.

In one embodiment, the oligomeric multifunctional thiols that are polysiloxanes are free of ester functionality, carbonate functionality, amide functionality, amine functionality, ethylenic unsaturation (e.g. carbon-carbon double bond), or a combination thereof. In another embodiment the polysiloxanes have a weight % molecular weight (MW) of between about 800 and about 10,000 and preferably about 2000 to about 8000.

The thiol-ene compositions can optionally contain a polymerization initiator, especially a photoinitiator. Conventional photoinitiators can be employed. Suitable photoinitiators include phosphine oxide photoinitiators; ketone-based photoinitiators, such as hydroxy- and alkoxyalkyl phenyl ketones, and thioalkylphenyl morpholinoalkyl ketones; benzoin ether photoinitiators; and the like.

Examples of suitable photoinitiators include 2-benzyl-2-(dimethylamino)-4′-morpholinobutyrophenone; 2-hydroxy-2-methylpropiophenone; benzophenone; trimethylbenzophenone; methylbenzophenone; 1-hydroxycyclohexylphenyl ketone; isopropyl thioxanthone; 2,2-dimethyl-2-hydroxy-acetophenone; 2,2-dimethoxy-2-phenylacetophenone; 2-methyl-1-[4-(methylthio)phenyl]-2-morpholino-propan-1-one; 2,4,6-trimethylbenzyl-diphenyl-phosphine oxide; 1-chloro-4-propoxythioxanthone; benzophenone; bis(2,6-dimethoxybenzoyl)-2,4,4-trimethyl pentyl phosphine oxide; 1-phenyl-2-hydroxy-2-methyl propanone; bis(2,4,6-trimethylbenzoyl)phenylphosphine oxide; camphorquinone; combinations of the foregoing; and the like. One or more polymerization initiators can be used.

The polymerization initiators can be used in amounts of at least about 0.25 weight percent, preferably about 0 to about 8 weight percent, specifically about 1 to about 7 weight percent, and more specifically about 2 to about 6 weight percent based on the total weight of the thiol-ene composition.

To provide improved adhesion to a substrate, one or more adhesion promoters may be present in the composition. To provide good adhesion to glass, a silane-based adhesion promoter can be employed such as those that can form a silanol group via hydrolysis. The silane-based adhesion promoter can contain an alkoxy group, aryloxy group, acetoxy group, amino group, a halogen atom, or the like bonded to a silicon atom, more specifically an alkoxy group. The silane-based adhesion promoter can also contain one or more unsaturated double bonds, for example allyl, vinyl, (meth)acryloxy, or (meth)acrylamido group in the molecule. The silane-based adhesion promoter may also optionally contain a mercapto group.

Exemplary adhesion promoters include γ-methacryloxypropyltrimethoxysilane, γ-acryloxypropyltrimethoxysilane, vinyl trimethoxysilane, γ-glycidoxypropyltriethoxysilane, γ-glycidoxypropyltrimethoxysilane, γ-aminopropyltriethoxysilane, γ-aminopropyltrimethoxysilane; γ-mercaptopropyltriethoxysilane, γ-mercaptopropyltrimethoxysilane, methyltrimethoxysilane, methyltriethoxysilane, phenyltrimethoxysilane, tetrabutoxysilane, tetrabutoxyzirconium, tetraiso-propoxyaluminum, bis-silyl amines such as SIB1833 from Gelest; the bis-silyl amines, diacrylated silane tertiary amines, acetoxy functional silanes, and trifunctional isocyanurates as provided in US Patent Application No. 2003/0129397 A1 incorporated herein in its entirety, combinations of the foregoing, and the like.

Additional exemplary adhesion promoters include acrylamido silanes according to the general formula (I) 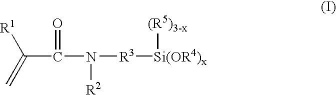
wherein R¹ and R² are each independently hydrogen or C₁-C₆ alkyl; R³ is C₁-C₃₀ alkylene, C₃-C₃₀ cyclic alkylene, C₂-C₃₀ heterocyclic alkylene, C₆-C₃₀ arylene including phenylene, or —R⁶-Z-R⁶— wherein R⁶ is C₁-C₃₀ alkylene, C₃-C₃₀ cyclic alkylene, C₂-C₃₀ heterocyclic alkylene, or C₆-C₃₀ arylene including phenylene, Z is O, S, S(O), S(O)₂, C(O), —N(R⁷)—, wherein R⁷ is C₁-C₁₋₅ alkyl, C₃-C₁₅ cyclic alkyl, C₂-C₁₅ heterocyclic alkyl, or C₆-C₂₀ aryl; each R⁴ is independently C₁-C₄ alkyl; each R⁵ is independently C₁-C₁₅ alkyl, C₃-C₁₅ cyclic alkyl, C₂-C₁₅ heterocyclic alkyl, C₆-C₂₀ aryl; and x is 1, 2, or 3.

In a specific embodiment, R¹ is hydrogen or methyl; R² is hydrogen or C₁-C₃ alkyl, including methyl, ethyl, n-propyl, or isopropyl; R³ is C₁-C₁₀ alkylene, C₆-C₁₅ arylene, each R⁴ is independently is C₁-C₄ alkyl; and x is 2 or 3. In a further embodiment, R¹ is hydrogen or methyl; R² is hydrogen; R³ is C₁-C₅ alkylene; each R⁴ is independently C₁-C₃ alkyl; and x is 3. In yet another embodiment, the acrylamido silane is CH₂═C(CH₃)C(O)NHCH₂CH₂CH₂Si(OCH₂CH₃)₃₋ₐ(OCH₃)ₐ, where the average value of a is 1. An exemplary acrylamido silane is Silquest A-178 or Silquest Y-5997 available from GE Advanced Materials.

The adhesion promoter can be present in the thiol-ene composition in an amount of 0 to about 30 weight percent, specifically about 1 to about 25 weight percent, and more specifically about 5 to about 20 weight percent based on the total weight of the thiol-ene composition.

In one embodiment, the curable thiol-ene composition can contain conductive fillers including carbon nanotubes, metal fibers, metal-coated fibers, conductive oligomers or polymers, and the like. Representative carbon nanotubes are described in U.S. Pat. No. 6,183,714 to Smalley et al, U.S. Pat. No. 5,591,312 to Smalley, U.S. Pat. No. 5,641,466 to Ebbesen et al, U.S. Pat. No. 5,830,326 to Iijima et al, U.S. Pat. No. 5,951,832 to Tanaka et al, U.S. Pat. No. 5,919,429 to Tanaka et al.

In another embodiment, the abrasion resistance of the cured composition can be improved by the addition of certain additives to the curable composition, including, for example, colloidal silica, alumina, and the like.

Other additives can optionally be included in the curable thiol-ene compositions including photosensitizers and/or stabilizers (including UV absorbers and light stabilizers), corrosion inhibitors, antioxidants, surfactants (for example, silicones, acrylics, or fluorosurfactants, each of which can be unsaturated or saturated), refractive index-adjusting additives, and/or colorants (dyes, pigments, and quantum dots). When used, the stabilizers can be present in an amount of about 0.001 to about 2 weight percent, specifically about 0.01 to about 0.5, and more specifically about 0.1 to about 0.3 weight percent based on the total weight of the composition. Surfactants can be used to lower the surface tension of the composition to improve wettability characteristics. Exemplary surfactants include fluorocarbon-based surfactants, for example FC-4430. Stabilizers can optionally be incorporated in the curable thiol-ene compositions to extend the shelf life of the curable composition.

The curable thiol-ene composition can be formed into ultra-thin curable films using a variety of methods, for example, dip coating, spin coating, roll coating, and the like. To aid in the process of forming the film, a solvent may be used in amounts sufficient to reduce the viscosity of the curable thiol-ene composition. Solvents may be chosen that will dissolve or disperse the components of the composition. Such solvents can include lower alkyl acetate solvents, for example ethyl acetate and the like; lower alkyl ketone solvents, for example acetone, methyl ethyl ketone, and the like; and lower alkyl alcohol solvents, for example methanol, ethanol, isopropanol, ethylene glycol, and the like. Prior to curing the ultra-thin film, the solvent can be removed by evaporation, optionally under vacuum.

The curable thiol-ene composition can be formed into a curable film having a thickness of less than about 15 micrometers, specifically less than 10 micrometers, more specifically less than one micrometer, yet more specifically less than about 500 nanometers (nm), still yet more specifically less than about 250 nm, more specifically less than about 100 nm, yet more specifically less than about 50 nm, or less than about 40 nm.

Once the curable thiol-ene composition has been formed into a curable film, it can be energy cured without the necessity of excluding oxygen to form a cured film. One particular method of energy curing would be with ultraviolet radiation. Exemplary sources of ultraviolet radiation include a Fusion H bulb, low pressure mercury vapor bulb, iron or gallium doped bulbs, and the like. In an exemplary embodiment, the curable compositions can be cured at a dose of about 0.75 Joule/centimeter², or less. It should be clear by the foregoing discussion that reaction products prepared by exposing the curable thiol-ene compositions to radiation energy are included herein.

The curable thiol-ene compositions, after undergoing rapid cure, produces an ultrathin coating exhibiting any one or a combination of properties including excellent hardness; abrasion resistance; chemical resistance including alkali, acid, and/or organic solvent resistance; minimal shrinkage; optical clarity; and high refractive index.

The optical clarity of the ultrathin cured coating exhibit excellent transmittance (in percent), clarity, and haze as measured according to ASTM D 1003 (method A) and excellent transmission values after abrasion as measured by ASTM D1044. The transmittance at 550 nm can be greater than or equal to about 88 percent, specifically greater than or equal to about 90 percent, more specifically greater than or equal to about 93 percent, and yet specifically greater than or equal to about 95 percent. The change in transmission after abrasion can be less than about 20 percent, specifically less than 15 percent, and more specifically less than about 10 percent as measured by ASTM D1044.

The haze of the ultrathin cured coatings can be less than about 10 percent, specifically less than about 5 percent, more specifically less than about 3 percent, and still yet more specifically less than about 1 percent as measured according to ASTM D1003 (method A).

The refractive of the ultrathin cured coating can be greater than or equal to about 1.48, specifically greater than or equal to about 1.49, more specifically greater than or equal to about 1.50, and yet specifically greater than or equal to about 1.51.

Depending upon the application, the curable thiol-ene compositions can be tailored to meet a desired hardness of the resulting ultrathin cured coating. Hardness can be determined using ASTM D3363-92A directed to pencil hardness. Exemplary ultrathin cured coatings can exhibit a pencil hardness of greater than or equal to about H, specifically greater than or equal to about 2H, more specifically greater than or equal to about 4H, and yet specifically greater than or equal to about 6H.

In one embodiment, the curable thiol-ene composition comprises a multifunctional thiol and multifunctional ethylenically unsaturated compound which are free of hydrolysable groups such as ester functionality or carbonate functionality. Such curable thiol-ene compositions, when cured, result in a cured film that is resistant to alkali solvents or base hydrolysis. As used herein “resistant to alkali solvents” or “resistant to base hydrolysis” means that a cured sample when exposed to a 5 Molar % sodium hydroxide aqueous solution at ambient temperature for 30 minutes results in no degradation of the film upon visual inspection.

The curable thiol-ene compositions can be applied onto a wide variety of substrates including, for example, glass, plastic, metal, paper, textile, wood and the like. In a specific embodiment, the curable compositions can be used to coat over thin conductive layers of material and then be cured to provide ultra-thin protective coatings, while not interfering with the conductive or optical properties of the system. Such thin conductive layers of material can comprise a thin layer of carbon nanotubes, sputtered indium tin oxide, conductive polymers or oligomers, nanodispersed conductive particles, and the like.

In yet another embodiment, the curable thiol-ene compositions can be filled with a conductive material and formed into ultra-thin layers and cured to form a conductive and optically clear film.

In another embodiment, the cured film prepared from the curable thiol-ene compositions is free of liquid crystal microdroplets.

Exemplary used of the cured thiol-ene compositions are for ultra-thin protective coatings and ultra-thin conductive films which find use in a variety of applications such as transparent thin film transistors and cathodic films as well as transparent anti-static coatings used in liquid crystal and plasma applications for the display market.

The invention is further illustrated by the following non-limiting examples.

### EXAMPLES

Table 1 contains the components of the curable thiol-ene compositions used in the following examples.

TABLE 1
Components of the formulations

| | |
|---|---|
| Components | Name |

Multifunctional thiol

| | |
|---|---|
| PTM | pentaerythritol tetra(3-mercapto propionate) |
| SMS-992 | (mercaptopropyl)methylsiloxane homopolymer |
| | available from Gelest, Inc. |

Multifunctional ethylenically unsaturated compound

| | |
|---|---|
| TAIC | Tri-allyl isocyanurate |

Polymerization initiators

| | |
|---|---|
| I-184 | Irgacure 184; 1-hydroxycyclohexylphenyl ketone |
| BP | benzophenone |
| MEHQ | Hydroquinone monomethylether |

Adhesion promoters

| | |
|---|---|
| A-178 | Methacrylamide functionalized silane |

Additives

| | |
|---|---|
| Irganox 1035 | Thiodiethylene bis(3,5-di-(tert)butyl-4- |
| | hydroxyhydrocinnamate (stabilizer) |
| G01-402 | stabilizer |
| Pyrogallol | Pyrogallol (stabilizer) |

### Examples 1-7

Table 2 contains the formulations for Examples 1-7 containing pentaerythritol tetra(3-mercapto propionate) as the multifunctional thiol compound; all amounts are in weight percent. The curable composition was prepared by combining all of the components, except the multifunctional thiol compound and adhesion promoter, at 60° C. with occasional stirring until a homogeneous mixture was obtained. The mixture was allowed to cool to room temperature before the remaining components were added with mixing to form the curable thiol-ene composition.

The curable thiol-ene compositions were measured for viscosity and wettability. Viscosity was measured using a Haake RV1 rheometer at 25° C. and a shear rate of 500 sec⁻¹. Wettability was determined visually by noting any surface defects such as edge crawl and dewetting.

The curable thiol-ene composition was diluted with isopropanol (IPA) and ethyl acetate [50/50 blend] (EA) to 10% solids. Drawdowns of the dilute mixture were prepared on glass and polyethylene terephthalate (PET) using a #3 Myer rod. The drawdowns were cured with a 600 W Fusion “H” bulb at 50 feet per minute (fpm). The cured drawdowns were tested for adhesion and solvent resistance. Adhesion was measured according to ASTM D3359 using 610 tape from 3M. Film thickness was 100 nm as measured by ellipsometry. The results are provided in Table 2.

Solvent resistance was measured by coating a glass slide, curing the coating, and exposing the cured drawdowns for 30 minutes to 5% w/w NaOH solution, 5% w/w H₂SO₄ solution, ethanol, isopropanol, or detergent. A ten minute exposure was used for N-methylpyrrolidone (NMP). A ‘pass’ was no removal of the coating. Changes in the optical properties of the coating were also noted.

TABLE 2

| | Example | | | | | | | |
|---|---|---|---|---|---|---|---|---|
| | | 1 | 2 | 3 | 4 | 5 | 6 | 7 |
| Component | | | | | | | | |
| TAIC | | 27.74 | 27.73 | 27.69 | 27.33 | 26.00 | 26.90 | 27.96 |
| Irganox 1035 | | | | | 1.00 | | | |
| G01-402 | | 0.40 | 0.40 | 0.40 | 0.40 | 0.40 | 0.40 | 0.02 |
| I-184 | | 2.00 | 2.00 | 2.00 | 2.00 | 2.00 | 2.00 | 2.00 |
| BP | | 0.02 | 0.02 | 0.02 | 0.02 | | | 0.02 |
| MEHQ | | 0.20 | | | | | | |
| Pyrogallol | | | 0.20 | 0.30 | 0.20 | 0.20 | 0.20 | 0.02 |
| PTM | | 49.64 | 49.65 | 49.59 | 49.05 | 51.40 | 50.50 | 49.98 |
| A-178 | | 20.00 | 20.00 | 20.00 | 20.00 | 20.00 | 20.00 | 20.00 |
| | Total | 100.00 | 100.00 | 100.00 | 100.00 | 100.00 | 100.00 | 100.00 |
| Properties | | | | | | | | |
| Crosshatch Adhesion | Glass | Pass | Pass | Fail | Fail | Fail | Pass | Pass |
| | PET | Pass | Pass | Pass | Pass | Pass | Pass | Pass |
| Wetting on glass | | Splotchy | Good | Poor | Poor | Poor | Good | Good |
| Solvent resistance | | | | | | | | |
| | 5% NaOH | Fail | Fail | Fail | Fail | Fail | Fail | Fail |
| | H₂SO₄ | Pass | Pass | Pass | Pass | Pass | Pass | Pass |
| | Ethanol | Pass | Pass | Pass | Pass | Pass | Pass | Pass |
| | IPA | Pass | Pass | Pass | Pass | Pass | Pass | Pass |
| | NMP | Pass | Pass | Pass | Pass | Pass | Pass | Pass |
| | | | | | (Hazy) | (Hazy) | | |
| | detergent | Pass | Pass | Pass | Pass | Pass | Pass | Pass |

As illustrated by the results, the cured compositions provide materials exhibiting excellent solvent resistance and good adhesion to PET.

### Examples 8-13

Examples 8-13 were prepared according to the procedure of Examples 1-7 above. Table 3 contains the formulations in parts by weight, and the results of testing for viscosity, adhesion, and pencil hardness. Pencil hardness was determined according to ASTM 3363.

TABLE 3

| | Example | | | | | | |
|---|---|---|---|---|---|---|---|
| | | 8 | 9 | 10 | 11 | 12 | 13 |
| Component | | | | | | | |
| TAIC | | 13.90 | 13.88 | 13.86 | 13.84 | 13.98 | 14.00 |
| G01-402 | | 0.20 | 0.20 | 0.20 | 0.20 | 0.01 | |
| I-184 | | 1.00 | 1.00 | 1.00 | 1.00 | 1.00 | 1.00 |
| BP | | 0.01 | 0.01 | 0.01 | 0.01 | 0.01 | 0.01 |
| Pyrogallol | | | 0.05 | 0.10 | 0.15 | 0.01 | |
| PTM | | 24.89 | 24.86 | 24.83 | 24.80 | 24.99 | 24.99 |
| A-178 | | 10.00 | 10.00 | 10.00 | 10.00 | 10.00 | 10.00 |
| | Total | 50.00 | 50.00 | 50.00 | 50.00 | 50.00 | 50.00 |
| mol thiol | | 0.2037 | 0.2035 | 0.2032 | 0.2030 | 0.2046 | 0.2046 |
| mol ene | | 0.2036 | 0.2034 | 0.2031 | 0.2029 | 0.2046 | 0.2048 |
| Properties | | | | | | | |
| Crosshatch adhesion | Glass | Pass | Fail | Pass | Pass | Pass | Pass |
| | PET | Pass | Fail | Pass | Pass | Pass | Pass |
| Pencil hardness | | 7H | 7H | 7H | 7H | 7H | 7H |

### Examples 14-18

Examples 14-18 were prepared according to the procedure of Examples 1-7 above, and are used to illustrate the differences between pentaerythritol tetra(3-mercapto propionate) (PTM) and (mercaptopropyl)methylsiloxane homopolymer (SMS-992) as the multifunctional thiol. Table 4 contains the formulations with the components in parts by weight, and the results of testing for viscosity, adhesion, solvent resistance, pencil hardness, and optical properties.

Percent transmission, haze, and clarity were measured using a Haze-Gard Plus from Byk-Garnder. The transmittance is the ratio of total light transmitted to incident light. Haze is the percentage of transmitted light that deviates from the incident beam by more than 2.5° on the average. Clarity is evaluated at less than 2.5° and is distance dependent. The following test procedures were used: ASTM D 1044 (without the conditioning step) and ASTM D 1003.

TABLE 4

| | Example | | | | | |
|---|---|---|---|---|---|---|
| | | 14 | 15 | 16 | 17 | 18 |
| Component | | | | | | |
| TAIC | | 6.88 | 6.78 | 10.88 | 2.88 | 6.88 |
| G01-402 | | 0.01 | 0.01 | 0.01 | 0.01 | 0.01 |
| I-184 | | 1.00 | 1.00 | 1.00 | 1.00 | 1.00 |
| Pyrogallol | | 0.01 | 0.01 | 0.01 | 0.01 | 0.01 |
| PTM | | — | 12.20 | — | — | — |
| SMS-992 | | 12.10 | — | 8.10 | 16.10 | 12.10 |
| A-178 | | 5.00 | 5.00 | 5.00 | 5.00 | 5.00 |
| | Total | 25.00 | 25.00 | 25.00 | 25.00 | 25.00 |
| mol thiol | | 0.1008 | 0.0999 | 0.0604 | 0.1201 | 0.0903 |
| mol ene | | 0.1010 | 0.0998 | 0.1491 | 0.0528 | 0.1010 |
| Properties | | | | | | |
| Crosshatch adhesion | Glass | Pass | Pass | | | |
| | PET | Pass | Pass | | | |
| Pencil hardness on PET | | 7H | 6H | 7H− | 6H | 7H− |
| Optical properties on PET | Light transmission (%) | 91.4 | 90.6 | Initial 92; | Initial 90.5; | Initial 91.5; |
| | | | | Taber 88.9 | Taber 88 | Taber 87.9 |
| | Haze | 2.3 | 0.9 | Initial 0.83; | Initial 0.75; | Initial 0.83; |
| | | | | Taber 47.7 | Taber 49.8 | Taber 45. 9 |
| | Clarity | 78.6 | 99.5 | Initial 99.6; | Initial 99.7; | Initial 99.7; |
| | | | | Taber 72.7 | Taber 78.5 | Taber 80.8 |
| Solvent resistance | | | | | | |
| | 5% NaOH | Did not | Dissolved | Pass | Pass | Pass |
| | | dissolve | completely | | | |

As illustrated by the results, the cured material from the formulation containing SMS-992 exhibited better alkali resistance than the PTM material. It is suggested that the absence of ester functionality in the SMS-992 provides better resistance to alkali solvents.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A cured film, comprising:
the reaction product obtained by radiation curing a curable thiol-ene composition, wherein the thiol-ene composition comprises
a multifunctional ethylenically unsaturated compound;
a multifunctional thiol compound; and
optionally a polymerization initiator, an adhesion promoter, a stabilizer, a surfactant, conductive filler, or a combination thereof,
wherein the cured film has a thickness of less than about 15 micrometers.

2. The cured film of claim 1, wherein the multifunctional thiol compound comprises two or more thiol groups per molecule and a polysiloxane backbone.

3. The cured film of claim 2, wherein the multifunctional thiol compound is (mercaptopropyl)methylsiloxane homopolymer, (mercaptopropyl)methylsiloxane copolymer, or a combination thereof.

4. The cured film of claim 2, wherein the multifunctional thiol has repeat units according to the general formula RₙSiO_{(4-n)/2};
wherein each R is independently i) a C₁-C₁₀ alkyl, optionally substituted with a thiol group or a halogen group or ii) an aryl group;
n is about 2;
where at least about 25 percent of the R groups per molecule are C₁-C₁₀ alkyl substituted with a thiol group and the remaining groups are unsubstituted C₁-C₁₀ alkyl.

5. The cured film of claim 2, wherein the multifunctional thiol is free of ester or carbonate groups.

6. The cured film of claim 1, wherein the ethylenic unsaturation is allyl, vinyl, acryloxy, methacryloxy, acrylamido, or methacrylamido.

7. The cured film of claim 1, wherein the ethylenic unsaturation is allyl or vinyl.

8. The cured film of claim 1, wherein the multifunctional ethylenically unsaturated compound is tri-allyl isocyanurate, tri-vinyl isocyanurate, triallyl triol, polyvinyl polyol, polyallyl polyol, polyvinyl polyetherpolyol, polyallyl polyetherpolyol, polyvinyl polyester polyol, vinyl terminated siloxane, allyl terminated siloxane, vinylalkylsiloxane homopolymers or copolymers, allylalkylsiloxane homopolymers or copolymers, allyl polysilsesquioxanes, vinyl polysilsesquioxanes, or a combination thereof.

9. The cured film of claim 1, wherein the multifunctional ethylenically unsaturated compound is free of ester or carbonate groups.

10. The cured film of claim 1, wherein the multifunctional ethylenically unsaturated compound is free of siloxane groups.

11. The cured film of claim 1, wherein the curable thiol-ene composition comprises a ratio of unsaturated functionality:thiol functionality of about 0.40:1.00 to about 2.50:1.00.

12. The cured film of claim 1, wherein the curable thiol-ene composition comprises a ratio of unsaturated functionality:thiol functionality of about 0.75:1.00 to about 1.25:1.00.

13. The cured film of claim 1, wherein the polymerization initiator is a photoinitiator.

14. The cured film of claim 1, wherein the adhesion promoter is a silane-based adhesion promoter optionally comprising an unsaturated double bond or mercapto functionality and wherein the adhesion promoter is present in the curable composition in an amount of up to about 30 weight percent based on the total weight of the composition.

15. The cured film of claim 1, wherein the conductive filler is carbon nanotube, metal fiber, metal-coated fiber, conductive polymer or oligomer, or a combination thereof.

16. The cured film of claim 1, wherein the film comprises a thickness of less than about 500 nanometers.

17. The cured film of claim 1, wherein the film exhibits one or more of the following properties:
no degradation when exposed to a 5% NaOH solution at ambient temperature for 30 minutes as indicated by visual inspection or light transmission;
less than about 5% loss in light transmission after exposure to a 5% NaOH solution at ambient temperature for 30 minutes;
no degradation when exposed to a 5% H₂SO₄ solution at ambient temperature for 30 minutes as indicated by visual inspection;
no degradation when exposed to ethanol, isopropanol, or neutral detergent at ambient temperature for 30 minutes as indicated by visual inspection;
transmittance of light at 550 nanometers as measured by ASTM D1003 method A of greater than about 90%;
adhesion to glass as measured according to ASTM D3359;
a pencil hardness of greater than or equal to 6H as measured according to ASTM D3363-92A;
a refractive index greater than about 1.48;
haze of less than about 10% as measured by ASTM D1003 (method A); and
a change in transmission after abrasion of less than about 10% as measured by ASTM D1044.

18. An article prepared from the cured film of claim 1.

19. The article of claim 18, wherein the article is a display.

20. The article of claim 18, wherein the cured film is a protective coating disposed on a substrate.

21. A cured film, comprising:
the reaction product obtained by radiation curing a curable thiol-ene composition, wherein the thiol-ene composition comprises
tri-allyl isocyanurate, tri-vinyl isocyanurate, triallyl triol, polyvinyl polyol, polyallyl polyol, polyvinyl polyetherpolyol, polyallyl polyetherpolyol, or a combination thereof;
(mercaptopropyl)methylsiloxane homopolymer, (mercaptopropyl)methylsiloxane copolymer, or a combination thereof; and
optionally a photoinitiator, an adhesion promoter, a stabilizer, a surfactant, conductive filler, or a combination thereof,
wherein the cured film has a thickness of less than about 15 micrometers.

22. A method of preparing a cured film, comprising:
preparing a curable thiol-ene composition;
forming a layer of curable thiol-ene composition; and
curing the curable thiol-ene composition to form a cured film;
wherein the curable thiol-ene composition comprises a multifunctional ethylenically unsaturated compound; a multifunctional thiol compound; and optionally a polymerization initiator, an adhesion promoter, a stabilizer, a surfactant, conductive filler, or a combination thereof; and wherein the layer of curable thiol-ene composition has a thickness of less than 1 micrometer.
